(19) United States
(12) Patent Application Publication
(10) Pub. No.: US 2010/0003601 A1
(43) Pub. Date: Jan. 7, 2010

(54) ELECTROCHEMICAL ENERGY SOURCE WITH A CATHODIC ELECTRODE COMPRISING AT LEAST ONE NON-OXIDIC ACTIVE SPECIES AND ELECTRIC DEVICE COMPRISING SUCH AN ELECTROCHEMICAL ENERGY SOURCE

(75) Inventors: Rogier Adrianus Henrica Niessen, Eindhoven (NL); Petrus Henricus Laurentius Notten, Eindhoven (NL); Johannes Hubertus Gerardus Op Het Veld, Eindhoven (NL); Remco Henricus Wilhelmus Pijnenburg, Hoogeloon (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/514,127

(22) PCT Filed: Nov. 9, 2007
(86) PCT No.: PCT/IB2007/054554

§ 371 Date: May 8, 2009

(30) Foreign Application Priority Data
Nov. 14, 2006 (EP) 06124008.1

(51) Int. Cl. H01M 4/54; H01M 4/02; H01M 4/58; H01M 4/56

(52) U.S. Cl. 429/219; 429/209; 429/231.95; 429/225; 29/623.5

(57) ABSTRACT

The invention relates to an electrochemical energy source, comprising a substrate and at least one electrochemical cell deposited onto said substrate, wherein the cell comprises an anodic electrode, a cathodic electrode and an electrolyte separating said anodic electrode and said cathodic electrode and wherein the cathodic electrode comprises at least one non-oxidic composition, said composition comprising active species. The invention disclosed in this document describes how a battery, consisting of a lithium alloy anodic electrode and a cathodic electrode made of this different class of materials mentioned above, might be a suitable alternative for a battery stack comprising conventionally used materials, especially in applications in which a high current capability is essential.

### FIELD OF THE INVENTION

The invention relates to an improved electrochemical energy source. The invention also relates to an electronic device provided with such an electrochemical energy source.

### BACKGROUND OF THE INVENTION

Electrochemical energy sources based on solid-state electrolytes are known in the art. These (planar) energy sources, or ‘solid-state batteries’, efficiently convert chemical energy into electrical energy and can be used as the power sources for portable electronics. At small scale such batteries can be used to supply electrical energy to e.g. microelectronic modules, more particular to integrated circuits (IC's). An example hereof is disclosed in the international patent application WO-A-00/25378, where a solid-state thin-film micro battery is fabricated directly onto a specific substrate. During this fabrication process the first electrode, the intermediate solid-state electrolyte, and the second electrode are subsequently deposited as a stack onto the substrate. Presently, a wide range of solid electrolytes exist that can be utilized in the thin film battery design. These include (among others) halide spinels (Li₂FeCl₄), halide rock salts (LiI, LiBr), sulphides (Li₂S—P₂S₅), nitrides (Li₃N), Garnet-type structured (Li₅La₃Ta₂O₁₂), Li-silicates (LiSiO₄, Li₉SiAlO₈), Pervoskites (Li_{2/3-3x}LaₓTiO₃) and Lithiumphosphorous-oxynitride (LiPON).

Most conventional Li-ion battery systems consist of a graphite (C) anodic electrode and a lithium-cobalt-oxide (LiCoO₂) cathode and can be efficiently used in applications like PDA's, notebooks etc. Nowadays, new application areas arise like implantables, small autonomous devices, smart cards, integrated lighting solutions (OLEDs) or hearing aids. These low-power and small-volume applications require batteries with a large volumetric energy/power density. The gravimetric energy/power density is of minor importance due to the small size. Therefore, excellent candidates to power these applications are thin film all solid-state batteries. These generally consist of a lithium metal (Li) anodic electrode and a metal-oxide (MOₓ) cathodic electrode. The (MOₓ) cathodic electrode herein generally comprises a layer 2D or 3D compound in which lithium is stored in its ionic form.

Two aspects are important to obtain the highest energy/power density possible. Firstly, as explained in patent application WO2005/027245A2, for etched substrates, the ratio between surface area/footprint can be maximized. Secondly, for a high volumetric energy density one should use electrode materials with a high volumetric charge density.

Conventionally used metal-oxide (MOₓ) cathode materials like LiCoO₂, LiNiO₂ or LiMn₂O₄ dictate to a very large extent the overall impedance of the battery. In a more simple sense, the resistance linked to insertion/extraction of lithium into/from these compounds is rather high, resulting in the fact that this is the limiting factor in the rate capability of the whole battery stack. This resistance is directly linked to several material-specific parameters like, for example, the semi-conducting nature of these oxidic materials that, especially at high lithium content, results in poor electronic conductivity. For conventional batteries about 90% of the total battery impedance is related to the cathodic electrode, whereas only 10% is related to the anodic electrode.

### SUMMARY OF THE INVENTION

The aim of the invention is to provide a battery of the kind referred to above wherein the electric conductivity of the cathodic electrode is improved, so that the battery is better suited for apparatuses and applications wherein high currents may be drawn from the battery.

This aim is achieved by an electrochemical energy source comprising a substrate and at least one electrochemical cell deposited onto said substrate, wherein the cell comprises an anodic electrode, a cathodic electrode and an electrolyte separating said anodic electrode and said cathodic electrode and wherein the cathodic electrode comprises at least one non-oxidic composition, said composition comprising active species.

Herein the active species is the species wherein the conversion from electrical energy into chemical energy and the reverse takes place. By replacing the metal-oxide cathode material with a different class of cathode materials, these limitations are overcome. The invention disclosed in this document describes how a battery, consisting of a lithium alloy anodic electrode and a cathodic electrode made of this different class of materials mentioned above, might be a suitable alternative for a battery stack comprising conventionally used materials, especially in applications in which a high current capability is essential.

Besides it is noted that this different class of cathode materials has electrode potentials different from those of prior art cathode materials, leading to a lower potential between the battery electrodes and hence to a lower energy density of the resulting battery. However, especially in applications wherein high current capabilities are required, the advantages obtained by the features of the invention may well offset the disadvantages of the lower energy density.

Although this feature according to the invention may be used in several different types of electrochemical energy sources, like those of the type containing hydrogen as the active species (NiMH batteries), a main field of application of the invention resides in such electrochemical energy sources wherein lithium is used as active species. Consequently a major embodiment provides the feature that the active species comprises lithium.

Although lithium may be present in a metallic or elemental structure, it is also possible that the lithium is present in an alloy compound in which lithium can be in its elemental (atomic) form or as an ion. By a consistent and smart choice of materials the conventionally used (layered) MOₓ cathode materials are replaced by lithium alloy materials. The proposed lithium alloy cathode materials have several advantages over the former MOₓ-based cathode materials namely:

1. Their electronic conductivity is higher as they are not mixed-conductor-type semi-conducting compounds.
2. The inherent diffusion of lithium in lithium alloys is generally higher than in oxidic (layered) compounds.
3. The need for preferential orientated deposition of the layered MOₓ materials, which has a huge impact on their electrochemical activity, is avoided.
4. The volumetric and gravimetric energy density is higher.

All these properties, which now hold for both the anodic electrode and cathodic electrode as they consist of lithium alloy compounds, result in an overall lower battery impedance, making this high energy-dense battery stack especially suitable for high-drain applications.

Yet another preferred embodiment provides the feature that the cathodic electrode comprises as least 90% lithium alloy by weight. It has appeared that with cathodic electrodes comprising such a content of lithium the effects of the invention are optimised. Herein it is noted that the main aim of the invention is to provide for a better conductivity of the electrode itself, which can only be reached when sufficient electrically conducting material is present in the electrode. The remaining material may be formed by material that is not electrochemically active like structural binders or carbon material.

It has appeared that the measures according to the invention are particularly advantageous in solid-state batteries. Consequently a preferred embodiment provides the feature that the electrochemical energy source is formed by a solid-state battery of which the cathodic electrode comprises at least one lithium alloy compound.

It has appeared to the inventors that the use of a lithium-antimony alloy (Li—Sb) in the cathodic electrode leads to particularly advantageous results, mainly resulting from the relative high cathode potential relative to high-energy dense lithium (Li) or lithium silicon (Li—Si) anodic electrodes, being an important factor in the energy density of the resulting battery. Further the same advantages as mentioned before are achieved, in particular the advantage of the higher electric conductivity, the higher inherent diffusion of lithium, the higher volumetric and gravimetric energy density, while the need for preferential orientated deposition of the layered MOₓ materials, which has a huge impact on their electrochemical activity, is avoided.

Likewise it has appeared to the inventors that the use of a lithium-bismuth alloy (Li—Bi) in the cathodic electrode leads to particularly advantageous results as well, also resulting from the relative high cathode potential relative to high-energy dense lithium (Li) or lithium silicon (Li—Si) anodic electrodes, being an important factor in the energy density of the resulting battery. Further the same advantages as mentioned before are achieved, in particular the advantage of the higher electric conductivity, the higher inherent diffusion of lithium, the higher volumetric and gravimetric energy density, while the need for preferential orientated deposition of the layered MOₓ materials, which has a huge impact on their electrochemical activity, is avoided.

Although a main field of application of the invention resides in Li-ion batteries, and other materials for use as active species are not excluded, the features of the invention may also be applied in batteries of other types, such as Nickel Metal Hydride (NiMH) batteries wherein the active species is hydrogen. Also in these electrodes the lack of oxides leads to a reduction of the internal impedance of the electrode.

Preferably, at least one electrode of the energy source according to the invention is adapted for storage of active species of at least one of following elements: beryllium (Be), magnesium (Mg), aluminium (Al), copper (Cu), silver (Ag), sodium (Na) and potassium (K), or any other suitable element which is assigned to group 1 or group 2 of the periodic table. So, the electrochemical energy source of the energy system according to the invention may be based on various intercalation mechanisms and is therefore suitable to form different kinds of (reserve-type) battery cells, e.g. Li-ion battery cells, NiMH battery cells, et cetera.

In a preferred embodiment at least one electrode comprises at least one of the following materials: C, Sn, Ge, Pb, Zn, Li and, preferably doped, Si. A combination of these materials may also be used to form the electrode(s). Preferably, n-type or p-type doped Si is used as electrode, or a doped Si-related compound, like SiGe or SiGeC. Also other suitable materials may be applied as anodic electrode, preferably any other suitable element which is assigned to one of groups 12-16 of the periodic table, provided that the material of the battery electrode is adapted for intercalation and storing of the abovementioned reactive species. The aforementioned materials are in particularly suitable to be applied in lithium ion based battery cells. In case a hydrogen based battery cell is applied, the anodic electrode preferably comprises a hydride forming material, such as AB₅-type materials, in particular LaNi₅.

By patterning or structuring one, and preferably both, electrodes of the electrochemical energy source according to the invention, a three-dimensional surface area, and hence an increased surface area per footprint of the electrode(s), and an increased contact surface per volume between the at least one electrode and the electrolytic stack is obtained. This increase of the contact surface(s) leads to an improved rate capacity of the energy source, and hence to an increased performance of the energy source according to the invention. In this way the power density in the energy source may be maximized and thus optimized. Due to this increased cell performance a small-scale energy source according to the invention will be adapted for powering a small-scale electronic device in a satisfying manner. Moreover, due to this increased performance, the freedom of choice of (small-scale) electronic components to be powered by the electrochemical energy source according to the invention will be increased substantially. The nature, shape, and dimensioning of the pattern may be various, as will be elucidated below. It is preferred that at least one surface of at least one electrode is substantially regularly patterned, and more preferably that the applied pattern is provided with one or more cavities, in particular pillars, trenches, slits, or holes, which particular cavities can be applied in a relatively accurate manner. In this manner the increased performance of the electrochemical energy source can also be predetermined in a relatively accurate manner. In this context it is noted that a surface of the substrate onto which the stack is deposited may be either substantially flat or may be patterned (by curving the substrate and/or providing the substrate with trenches, holes and/or pillars) to facilitate generating a three-dimensional oriented cell.

Preferably, each electrode comprises a current collector. By means of the current collectors the cell can easily be connected to an electronic device. Preferably, the current collectors are made of at least one of the following materials: Al, Ni, Pt, Au, Ag, Cu, Ta, Ti, TaN, and TiN. Other kinds of current collectors, such as, preferably doped, semiconductor materials such as e.g. Si, GaAs, InP may also be applied to act as current collector.

The electrochemical energy source preferably comprises at least one barrier layer being deposited between the substrate and at least one electrode, which barrier layer is adapted to at least substantially preclude diffusion of active species of the cell into said substrate. In this manner the substrate and the electrochemical cell will be separated chemically, as a result of which the performance of the electrochemical cell can be maintained relatively long-lastingly. In case a lithium ion based cell is applied, the barrier layer is preferably made of at least one of the following materials: Ta, TaN, Ti, and TiN. It may be clear that also other suitable materials may be used to act as barrier layer.

In a preferred embodiment preferably a substrate is applied, which is ideally suitable to be subjected to a surface treatment to pattern the substrate, which may facilitate patterning of the electrode(s). The substrate is more preferably made of at least one of the following materials: C, Si, Sn, Ti, Ge, Al, Cu, Ta, and Pb. A combination of these materials may also be used to form the substrate(s). Preferably, n-type or p-type doped Si or Ge is used as substrate, or a doped Si-related and/or Ge-related compound, like SiGe or SiGeC. Beside relatively rigid materials, also substantially flexible materials, such as e.g. foils like Kapton® foil, may be used for the manufacturing of the substrate. It may be clear that also other suitable materials may be used as a substrate material.

When dictated by the application the electrochemical battery may be embodied in a flexible structure by making the substrate of a flexible material, like Kapton® or a metal foil.

Yet another preferred embodiment provides a battery unit, comprising at least one electrochemical energy source according to one of the preceding claims. This battery unit makes an advantageous use of the features of the invention. This counts in particular, but not exclusively when the battery pack is adapted to supply apparatuses requiring high currents.

The invention also provides an electrical device comprising an electrochemical energy source as claimed in any of the claims 1-18. Also in such an embodiment the fruitfull effects of the invention appear very well. This is in particular the fact if the electrical device comprises an electrical energy consuming component adapted to draw relatively high currents, like an small autonomous electric device, like a wirelessly communicating implantable biosensor or a power tool, like an electric drill.

The invention also relates to a method for manufacturing an electrochemical energy source of the kind referred to above the method comprising the steps of depositing an anodic electrode layer on a substrate, depositing a solid-state electrolyte layer on the anode and depositing a cathode layer containing a lithium alloy on the electrolyte layer.

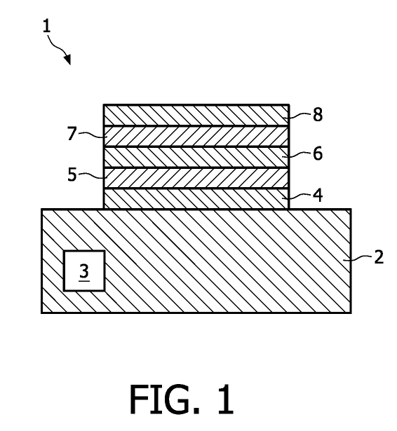

Subsequently the invention will be elucidated with the help of the accompanying FIG. 1, showing a cross section of an embodiment of the invention.

### DETAILED DESCRIPTION OF THE INVENTION

Although the invention is not limited to a solid-state battery, this type of battery is one of the main fields of application. The invention is thus explained with the help of such a structure.

The solid-state battery 1 depicted in FIG. 1 is based on a substrate 2 comprising, for instance, silicon, but other types of substrate materials are not excluded. Electronic devices, like a transistor 3 may be incorporated into the substrate 2. On this substrate 2 a current collector layer 4 is deposited. This current collector layer 4 may have also the function of a barrier layer. On this collector layer 4 a cathode layer 5 is deposited, which, according to the invention comprises non-oxidic lithium compound. On the cathode layer an electrolyte layer 6 is deposited, whereon the anodic electrode layer 7 has been deposited. The structure is completed by a second current collector layer 8 deposited on the anode layer 7. Electrical connections are made to both current collector layers 4 and 8.

Because traditional layered MOₓ-based cathode materials dominate the overall battery impedance, they are replaced by lithium alloy compounds. The apparent advantages over the former were already denoted above. Two prime examples of possible lithium alloy materials that can be used as cathode materials are lithium-antimony (Li—Sb) or lithium-bismuth (Li—Bi). These are especially suitable as they; (i) exhibit a very high energy density and (ii) have (de)intercalation potentials situated sufficiently more positive than the proposed lithium alloy materials, resulting in a decent battery potential. Although in principle independent from the feature of the invention, the anode may also be made of metallic lithium.

### Ad (i):

Research by Huggins et al. has shown that at room temperature Sb and Bi are able to store up to three lithium atoms per host atom (see Table 1). This corresponds to 660 mAh/g and 385 mAh/g for Sb and Bi, respectively. In general conventionally used MOₓ cathode materials only have a gravimetrical energy density of about 130 mAh/g. In this respect your attention is drawn to the following table 1.

| Voltage | | | Temperature | |
|---|---|---|---|---|
| vs. Li | System | Range of y | (° C.) | Reference |
| 0.810 | Li_{y}Bi | 1-3 | 25 | [22] |
| 0.828 | Li_{y}Bi | 0-1 | 25 | [22] |
| 0.948 | Li_{y}Sb | 2-3 | 25 | [22] |
| 0.956 | Li_{y}Sb | 0-2 | 25 | [22] |

### Ad (ii):

It furthermore shows that the insertion/extraction potential of Li—Sb is about 0.95 V vs. Li/Li⁺ and that of Li—Bi is about 0.815 V vs. Li/Li⁺ (see Table 1).

Taking the data shown in Table 1 into account one can calculate the gravimetric (CapM) and volumetric energy density (CapV) of these lithium alloy cathodes and compare these to a conventional MOₓ-based cathode. This is shown in Table 2.

TABLE 2
Gravimetric and volumetric energy densities of lithium
alloy (top) and lithium-metal-oxide cathodes (bottom).

| | | Ins./extr. potential | Cap_{M} | Cap_{V} |
|---|---|---|---|---|
| Cathode | x | [V] | [mAh/g] | [mAh/μm · cm²] |
| LiₓBi | 0 → 3 | 0.828 → 0.810 | 385 | 0.376 |
| LiₓSb | 0 → 3 | 0.956 → 0.948 | 660 | 0.442 |
| LiₓCoO₂ | 0.5 → 1 | 4.4 → 3.4 | 137 | 0.070 |

Additionally, one can use lithium alloy anodes. Calculating again the gravimetric (Cap_{M}) and volumetric energy density (Capᵥ) of these compounds yields the data in Table 3. Here, the conventionally-used graphite and metallic lithium anodes are included also.

TABLE 3
Gravimetric and volumetric energy densities of lithium
alloy (top) and conventional anodes (bottom).

| | Ins./extr. potential | Cap_{M} | Cap_{V} |
|---|---|---|---|
| y | [V] | [mAh/g] | [mAh/μm · cm²] |
| 4.2 → 0 | 0.5 → 0.1 | 4006 | 0.934 |
| 4.4 → 0 | 0.8 → 0.4 | 995 | 0.724 |
| — | 0 → 0 | 3862 | 0.206 |
| 0.16 → 0 | 0.3 → 0 | 375 | 0.084 |

Finally, the overall volumetric energy density (ED) of the battery stack (anode+cathode) can be calculated using combinations of the electrode materials listed in Tables 2 and 3. The resulting data for some of these combinations is shown in Table 4.

TABLE 4
Volumetric energy densities of complete battery
stacks comprising lithium alloy electrodes (top)
and conventional electrodes (bottom).

| | | U_{EMF} | E_{D} |
|---|---|---|---|
| Anode | Cathode | [V] | [mWh/μm · cm²] |
| Li_{y}Si | LiₓBi | 0.828-0.310 | 0.082 |
| Li_{y}Si | LiₓSb | 0.956-0.448 | 0.107 |
| Li | LiₓCoO₂ | 4.4 → 3.4 | 0.203 |
| C | LiₓCoO₂ | 4.4 → 3.1 | 0.135 |

Summarizing, table 4 shows that the volumetric energy density of the complete battery stack is somewhat lower in the case the stack consists of a lithium alloy anode and cathode (Li—Si and Li—Sb), as compared to a conventional stack (C and LiCoO₂). This reduction is about 20%. However, as no MOₓ-based cathode is used, the overall battery impedance of this stack will be lower due to the superior materials properties of the lithium alloy cathode. This will result in the fact that this battery will be more suitable for high-drain applications. In essence, depending on the precise application it might be worthwhile to sacrifice some of the volumetric energy density.

One additional, but very important, note regarding the integration of such lithium alloy-based batteries should also be made: The stack consisting of a lithium alloy anode and cathode generally has a much lower battery potential as compared to the conventional case (see Table 4). This might be a definite advantage in the future, as, for example, IC-based electronics tend to shift to low-power/voltage operation. A lower battery potential will result in a better match in this case (less losses due to converting to the proper voltage).

It should be noted that metallic lithium, instead of Li—Si, could also be utilized as anode material in combination with a lithium alloy (Li—Sb or Li—Bi) cathode.

1. Electrochemical energy source, comprising:
a substrate, and
at least one electrochemical cell deposited onto said substrate, the cell comprising:
an anodic electrode,
a cathodic electrode, and
an electrolyte separating said anodic electrode and said cathodic electrode;
wherein the cathodic electrode comprises at least one non-oxidic composition, said composition comprising active species.

2. Electrochemical energy source as claimed in claim 1, characterized in that the active species comprises lithium.

3. Electrochemical energy source as claimed in claim 2, characterized in that the cathodic electrode comprises at least one lithium alloy compound.

4. Electrochemical energy source as claimed in claim 1, characterized in that the cathodic electrode comprises as least 90% lithium alloy by weight.

5. Solid-state battery, comprising an electrochemical energy source as claimed in claim 3, characterized in that the anodic electrode comprises a lithium alloy compound and that the lithium alloy compound in the cathodic electrode has an electrode potential different from the electrode potential of the lithium alloy compound in the anodic electrode.

6. Solid-state battery as claimed in claim 1, characterized in that the cathodic electrode comprises a lithium-antimony alloy (Li—Sb).

7. Solid-state battery as claimed in claim 1, characterized in that the cathodic electrode comprises a lithium-bismuth alloy (Li—Bi).

8. Electrochemical energy source as claimed in claim 1, characterized in that the active species is hydrogen.

9. Electrochemical energy source as claimed in claim 1, characterized in that at least one of the anodic electrode and the cathodic electrode are adapted for storage of active species of at least one of following elements: Be, Mg, Cu, Ag, Na, Al and K.

10. Electrochemical energy source as claimed in claim 1, characterized in that at least one of the anodic electrode and the cathodic electrode is made of at least one of the following materials: C, Sn, Ge, Pb, Zn, Bi, and, preferably doped, Si.

11. Electrochemical energy source as claimed in claim 1, characterized in that at least one electrode is provided with at least one patterned surface.

12. Electrochemical energy source as claimed in claim 1, characterized in that the at least one patterned surface of the at least one electrode is provided with multiple cavities.

13. Electrochemical energy source as claimed in claim 11, characterized in that at least a part of the cavities form pillars, trenches, slits, or holes.

14. Electrochemical energy source as claimed in claim 1, characterized in that the anodic electrode and the cathodic electrode each comprise a current collector.

15. Electrochemical energy source as claimed in claim 14, characterized in that the at least one current collector is made of at least one of the following materials: Al, Ni, Pt, Au, Ag, Cu, Ta, Ti, TaN, and TiN.

16. Electrochemical energy source as claimed in claim 1, characterized in that the energy source further comprises at least one electron-conductive barrier layer being deposited between the substrate and at least one electrode, which barrier layer is adapted to at least substantially preclude diffusion of active species of the cell into said substrate.

17. Electrochemical energy source as claimed in claim 16, characterized in that the at least one barrier layer is made of at least one of the following materials: Ta, TaN, Ti, and TiN.

18. Electrochemical energy source according to claim 1, characterized in that the substrate comprises Si and/or Ge.

19. Electrochemical energy source as claimed in claim 1, characterized in that the substrate is made of a flexible material, like Kapton® or a metal foil.

20. Battery unit, comprising at least one electrochemical energy source according to claim 1.

21. Electrical device, comprising at least one electrochemical energy source according to claim 1.

22. Electrical device as claimed in claim 21, comprising an electrical energy consuming component adapted to draw relatively large currents, like a wirelessly-communicating implantable biosensor or an electric motor in a power tool.

23. Method for manufacturing an electrochemical energy source according to claim 1, comprising the steps of:
depositing an cathodic layer on a substrate;
depositing a solid-state electrolyte layer on the cathodic layer; and
depositing an anodic layer containing lithium on the electrolyte layer.
